(19) United States
(12) Patent Application Publication
(10) Pub. No.: US 2026/0141392 A1
(43) Pub. Date: May 21, 2026

(54) AUTHENTICATION USING PAYMENT ACCOUNT TRANSACTION DATA

(71) Applicant: MASTERCARD INTERNATIONAL INCORPORATED, PURCHASE, NY (US)

(72) Inventors: Jung PARK, Scarsdale, NY (US); Ishfaq LONE, Rathcoole (IE); Julia SCIORTINO, Wingdale, NY (US); Laurent HUENAERTS, New York, NY (US); Michael HOOLE, Epsom (GB); Piyushkumar Kanubhai HIRPARA, Dublin (IE); Prashanna S. TIWAREE, Castro Valley, CA (US)

(21) Appl. No.: 18/954,484

(22) Filed: Nov. 20, 2024

(51) Int. Cl. G06Q 20/40

(52) U.S. Cl. CPC G06Q 20/4016

(57) ABSTRACT

An account holder is authenticated using payment account transaction data. In one example, an authenticator receives an authentication request to authenticate the account holder from an organization. The request includes details of a past transaction provided to the organization by the account holder. In response to the authentication request, a response is communicated to the organization, indicating approval or denial of the authentication request based on whether the details of the past transaction match information stored in a transaction database managed by the payment network.

### BACKGROUND

Financial data is needed by individuals and organizations looking to manage expenses. When a consumer makes a purchase using a payment account, such as a credit or debit card account, the transaction data is provided by the merchant to the acquirer bank—the merchant's bank—which routes this information through a payment network (e.g., Mastercard, Visa, American Express, etc.) to the issuer bank, i.e., the consumer's bank account, which then approves or denies the transaction. As used herein, the term, “bank” refers to banks and other financial institutes that provide checking, savings, or other accounts that maintain a monetary or asset value on behalf of individuals and organizations.

Consumers can review their expenses by looking at their bank statement, which will include a list of charges corresponding to purchases made using the payment account. However, some consumers have multiple credit cards. In addition, some organizations that make purchases have a large number of employees, such as travelling executives or sales representatives, that make purchases that must be reimbursed or paid directly by the organization. Gathering financial data corresponding to these purchases into a single list, from just the various bank statements provided by the issuer bank is prohibitively time consuming or costly.

Many banks have implemented secured application programming interfaces (APIs) to link payment accounts with expense management services. Such services are often provided by certain banks and also by independent organizations that exist to provide accounting tools to consumers and organizations. An industry standard that has been developed is referred to as 3-D Secure Non-Payment Authentication, also called “3DS NPA.” 3-D Secure is an authentication process for authenticating account holders during online purchases. 3DS NPA involves using the 3DS protocol to verify an account holder's identity for transactions that do not involve a payment, such as to authenticate a request to share the account holder's transaction data with a third party.

An authentication process is a process designed to determine to a high degree of confidence that the person (or entity) being authenticated is truly the person (or entity) they purport to be. Traditional approaches to authentication require the person being authenticated to prove that they know something or have something that only the person being authenticated would know or have. For example, this often includes a username/password combination (something they know) or providing a code received at the person's cell phone via text (proving they have the phone). In order for these approaches to work, the authenticator (i.e., the entity requiring proof that the person is who they say they are) must have a pre-existing relationship with the person being authenticated. The authenticator must be able to confirm the username and password are correct or must have previously established the correct phone number to send the code. The 3DS process performed by banks have such a pre-existing relationship with their account holders and this is relied upon for carrying out the 3DS process.

The 3DS NPA process is initiated by third party service provider, such as an expense management platform, accessing the issuer's Access Control Server (ACS), which then connects directly to the account holder to authenticate the account holder, e.g., using log-in credentials and/or available multi-factor authentication techniques. Once the authentication procedure completes, the third-party service provider is provided with a token that grants access to the payment account transaction data. Notably, while the issuer has different methods of authentication (e.g., an account holder logs into their banking app and click's “yes”) the 3DS NPA process completes without the service provider ever receiving the account holder's login credentials to the account holder's issuer bank account. Once authorization is obtained by receipt of the token, the third-party service provider uses application programming interfaces (APIs) provided by the payment network and/or issuer bank to retrieve the account holder's transaction data. In many instances, the APIs provide real-time updates to transaction data. These real-time updates include transaction data for recently occurring payment transactions, such as within the last several minutes or even within the last few seconds.

Unfortunately, not all banks provide 3DS NPA authentication services or provide transaction data from an account holder's payment account with a third party, which is frustrating for some consumers and organizations looking to automate expense management. Expense data for the account holder is also held by the payment network, but the payment network typically does not have a pre-existing relationship with the account holder that could allow the account holder to authenticate themselves (e.g., using a username/password combination, text-based authentication, or otherwise). Therefore, the 3DS process cannot generally be implemented by payment networks. Heretofore, absent such a pre-existing relationship, it has not been possible for a payment network to authenticate account holders with a high level of confidence that the person being authenticated is who they say they are.

### SUMMARY

Example solutions for account holder authentication are described herein. The disclosed examples are described in detail below with reference to the accompanying drawing figures listed below. The following summary is provided to illustrate some examples disclosed herein.

In certain examples, an account holder is authenticated using payment account transaction data. In one example, an authenticator receives an authentication request to authenticate the account holder from an organization. The authentication request includes details of a past transaction provided to the organization by the account holder. In response to the authentication request a response is communicated to the organization, indicating approval or denial of the authentication request based on whether the details of the past transaction match information stored in a transaction database managed by the payment network.

### BRIEF DESCRIPTION OF THE DRAWINGS

The disclosed examples are described in detail below with reference to the accompanying drawing figures listed below:

FIG. 1 shows a schematic diagram illustrating by way of example a scenario for authenticating an account holder;

FIG. 2 shows a flowchart illustrating by way of example a method for authenticating an account holder;

FIG. 3 shows a time-space diagram illustrating by way of example a method for authenticating an account holder;

FIG. 4 shows another time-space diagram illustrating by way of example another approach for authenticating an account holder;

FIG. 5 shows yet another time-space diagram illustrating by way of example yet another approach for authenticating an account holder;

FIG. 6 shows by way of example a graphical user interface for collecting authentication data from a user;

FIG. 7 shows by way of example a computing platform suitable for implementing the methods illustrated in FIGS. 2-5.

Corresponding reference characters indicate corresponding parts throughout the drawings. Any of the figures may be combined into a single example or embodiment.

### DETAILED DESCRIPTION

The technology described herein improves the security of payment-related and non-payment transactions among third party organizations such as expense management services, merchants, etc., by employing past transaction data, which comprises information known only to the account holder, the issuer bank, and the payment network, as a secret key for authenticating the account holder. The technology provides authentication processes that vary in strength depending upon the assessed risk that the person requesting authentication is not the true account holder, wherein a perceived increased risk is met with increased authentication requirements, such as details of multiple transactions with different vendors or details associated with a strongly authenticated transaction that employed multi-factor authentication techniques.

Compared with prior authentication approaches, the present approach does not require involvement of an issuer, and no login or stateful relationship (such as maintaining login credentials by either the account holder or the payment network) is required. A secure application programming interface (API) is exported by the payment network which may be accessed by any authorized organization to submit account holder authentication requests. Complex token exchange protocols such as 3DS NPA protocols are not needed. Instead, the present approach provides a mechanism for an account holder to select a historical transaction that meets certain criteria, such as that it is at least 60 days in the past, and provide details of that past transaction, including the date and currency amount of the transaction. The payment network, without any login process, is able to then confirm the details of the transaction against its own transaction database and authenticate the account holder on the basis that only the account holder would have access to this past transaction information. To further strengthen the authentication, the user could be required to submit details of multiple past transactions with different merchants.

The solution is flexible to accommodate various scenarios, such as where the payment account is a long-standing account or where the payment account is a new account that lacks significant transaction history. It is also able to tailor the strength of the authentication based on an assessed risk determined by the payment network that the user is not be the person that they are portraying themselves to be. In some implementations, the assessed risk is determined based on information available to the payment network by applying heuristics to transaction data. In this manner, a score is calculated indicating a level of risk that payment card information or even physical possession of the payment card has shifted from the rightful account holder. In certain examples, such information includes one or more of changes in purchasing patterns, changes in purchase location, including time zone information, changes in user device attributes, and age of the account. The assessment, for example, generates a score or risk level corresponding to the perceived risk, which is calculated using heuristics based on the aforementioned data. In an alternative approach, the assessment is carried out by a trained machine learning (ML) model that is trained on data associated with transaction data known to be associated with compromised and uncompromised payment accounts. If the assessed risk is above a threshold, then additional details of prior transactions or details of additional prior transactions may be demanded before authentication is approved.

The solution is also capable of strongly authenticating account holders when the payment account lacks sufficient transaction history. In this instance, the authentication request may be placed by the payment network into a pending status. Only after one or more purchases meet specified criteria will the authentication be later approved.

In the following description, the several drawings will be referenced wherein like elements are identified by the same reference number.

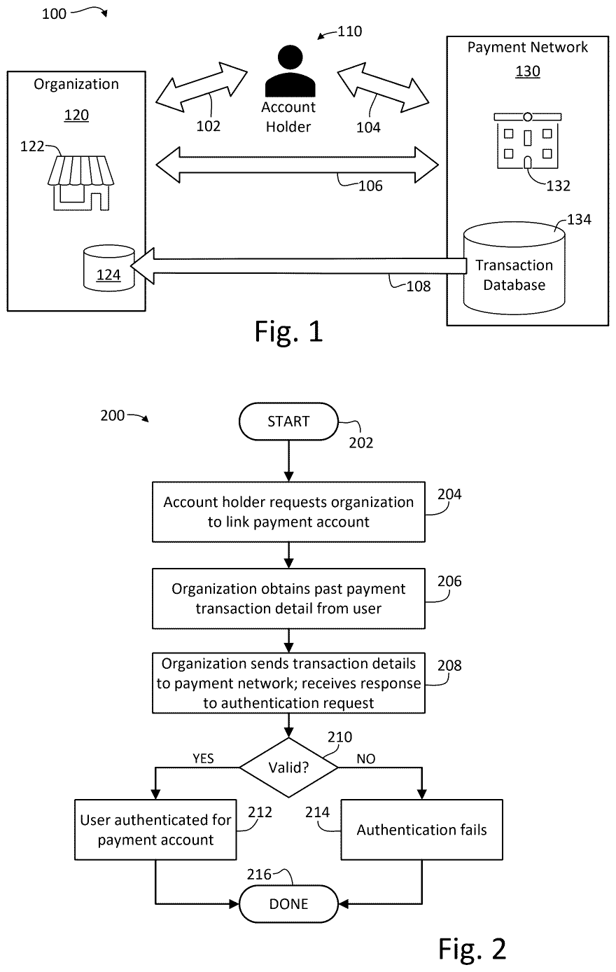

FIG. 1 illustrates by way of example a schematic representation 100 of entities and their relationships when participating in an authentication procedure using transaction data. Account holder 110 may be a person or agent thereof in possession of a payment card or other account for making payments. Alternatively, account holder 110 may be an organization or a representative or agent of an organization that holds a payment account, such as a debit or credit account. A payment account is an account that is provided by an issuer and is linked to a payment network, such as a card network. Payment accounts are typically used for the purpose of making payments for purchases of goods and services.

Organization 120 is any third-party organization such as a merchant, service provider, or other financial institution with an established relationship 102 with account holder 110. Organization 120 includes physical resources 122 that include physical and compute infrastructure for providing services to account holder 110. Such compute infrastructure may be directly owned and controlled by organization 120 or may be leased from a cloud or datacenter services provider. In addition, organization 120 maintains a database 124 for securely storing transaction data or other account details associated with account holder 110.

In certain use cases, organization 120 is a service provider, such as an expense management service provider that provides expense management services directly to account holder 110 or the employer (not shown) of account holder 110. In an alternatively use case, organization 120 is a merchant or other entity seeking one or more monetary payments from account holder 110 via payment network 130. Regardless of the nature of organization 120, pertinent to its relationship with account holder 110, organization 120 requires transaction data corresponding to a payment account maintained by account holder 110 with an issuer bank (not shown). In lieu of obtaining the transaction data from the issuer bank, which is a circumstance that occurs when the issuer bank does not provide transaction data as a service to account holders or their party organizations, or is incapable of processing a 3DS authentication procedure, the organization 120 may establish a secure communication channel 106 with payment network 130.

Payment network 130 may be any payment network that processes transactions on behalf of issuer and acquirer banks. Specifically, payment network 130 acts as an intermediary between acquirer banks associated with merchants and issuer banks associated with consumers. When a consumer makes a purchase with a merchant, the merchant's bank (e.g., the acquirer bank) transmits a transaction request via payment network 130 to the issuer bank that extends credit or holds assets on behalf of consumer with which the transaction is to be settled. As such, account holder 110 maintains an indirect relationship 104 with payment network 130. Although direct communication is possible, it typically occurs through acquirer and issuer bank intermediaries. If the issuer bank approves the transaction, payment network 130 effectuates the transfer of funds from the issuer bank to the acquirer bank. Payment network 130 includes physical and compute resources 132. Compute resources may be directly owned and controlled by payment network 130 or may be leased from a cloud or datacenter service provider. As a part of its role as intermediary, payment network 130 ensures the account holder and payment details related to a transaction are authentic, ensures communications between itself and acquirer and issuer banks are secure, and maintains a record of transactions in a transaction database 134.

While examples described herein involve payment network 130 acting as the authenticating entity, another entity (not shown) may likewise provide authentication services and is referred to herein generically as “the authenticator.” As explained in detail below, the authenticator will receive an authentication request including details of a past transaction provided by account holder 110 and compare these details with transaction data stored in transaction database 134 of payment network 130. Thus, the authenticator has access to the transaction database, e.g., via a secure application programming interface (API).

Communication channel 106 is representative of one or more communication channels, including internet, proprietary wide area networks, local networks, wireless networks, etc. In an example implementation, communication channel 106 includes an application programming interface (not shown) exposed by payment network 130 which authorized entities such as organization 120 may access to obtain services from payment network 130.

Upon successful authentication of account holder 110, transaction data associated with account holder's payment account may be communicated to organization 120 as represented by arrow 108. Transaction data may be communicated via communication channel 106 or a separate communication channel. In this example, transaction data associated with account holder 110 is communicated from transaction database 134 managed by payment network 130 to database 124 maintained by organization 120.

FIG. 2 shows a flowchart 200 illustrating by way of example a procedure for authenticating account holder 110 using transaction data. The procedure includes communications between account holder 110, organization 120, and payment network 130. In an example implementation, the procedure illustrated by flowchart 200 is implemented upon a failure or inability of organization 120 to successfully perform a 3DS authentication process with the issuer bank (not shown).

Flowchart 200 begins with start block 202 and flows to operation 204 wherein account holder 110 requests organization 120 to link to their payment account. In operation 206, organization 120 obtains details of one or more past transactions, such as payment transactions related to a purchase by account holder 110. Account holder 110 can review past transactions by accessing their issuer bank's website or bank statement. An example user interface useful for collecting the transaction details from the account holder is described in more detail below with reference to FIG. 6. Requested details may include one or more of a transaction amount, a transaction date, a transaction category, and a transaction type. In one example implementation, account holder 110 is instructed to select a transaction that occurred more than a certain number of days before the current date. For example, account holder 110 may be instructed to select any transaction that occurred more than 90 days ago. In another example embodiment, there may not be a transaction history if the account is recently created. In such a scenario, account holder 110 would be informed that the authentication request is placed in a pending status (e.g., “authentication-pending”) with an instruction that a certain number or type of transaction is needed before authentication is granted. Example authentication types include (1) where the user is strongly authenticated using multi-factor authentication techniques (described in more detail below) in the course of processing a new transaction, (2) where the user presents a payment card in the course of processing a new transaction, or (3) where a new transaction is for a dollar amount greater than a threshold amount such as $500. If none of these transaction types apply, account holder 110 could be asked to complete multiple transactions before authentication can be granted. In each case, the user is required to enter transaction details related to those past transactions once they occur in operation 206.

In operation 208, organization 120 transmits to the payment network the transaction details obtained from account holder 110 in operation 206. This operation may be completed by a first application executing on compute infrastructure managed by organization 120 contacting an API exposed by a second application executing on compute infrastructure managed by payment network 130. In such an instance, the first application will authenticate itself using existing authentication and authorization technologies such as OAuth which relies on cryptographic certificates. Once the communication channel is established, the first application transmits to payment network 130 via the API the transaction details obtained from account holder 110.

Assuming the first application is authorized to submit an authentication request on behalf of account holder 110, payment network 130 performs a validation procedure 210 that at least includes a comparison of the details of the transaction obtained from account holder 110 with details of the same transaction maintained in transaction database 134 maintained by payment network 130. If the comparison results in a match then the procedure flows to operation 212 wherein the account holder 110 is authenticated for the payment account. Thereafter, organization 120 is permitted to link payment account owned by account holder 110 to provide the services according to relationship 102 between account holder 110 and organization 120. If the comparison does not result in a match then the procedure flows to operation 214 wherein the authentication request is denied. In either case, the procedure ends as indicated by done block 216.

The above-described example assumes that payment network 130 acts as the authenticator. However, alternate implementations are contemplated in which a separate entity serves as the authenticator. In such an instance the authenticator validates the details of the transaction obtained from the account holder with details of the same transaction fetched from transaction database 134 managed by the payment network, e.g., via an API made available to the authenticator.

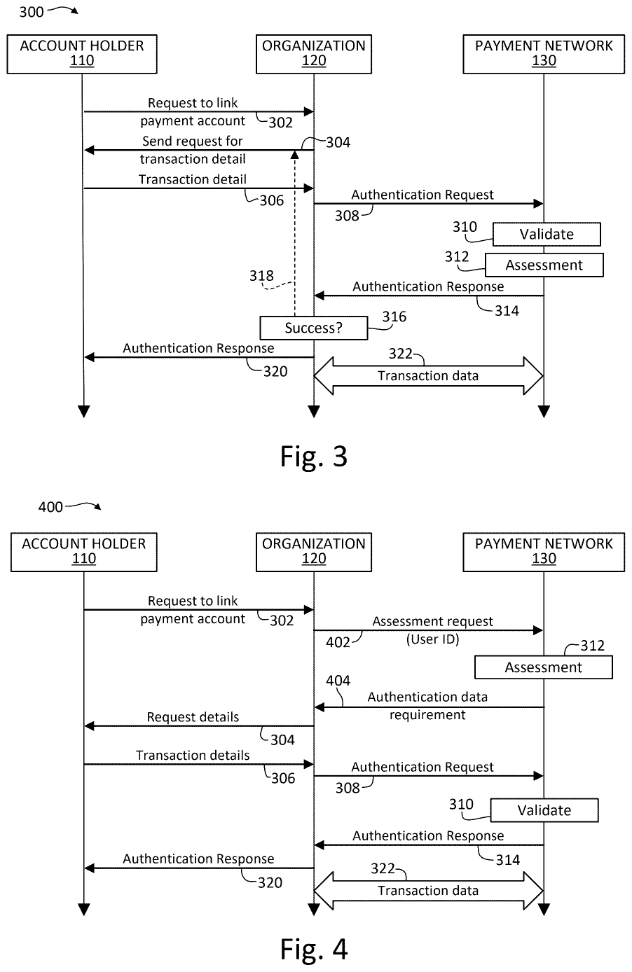

FIG. 3 shows a time-space diagram 300 illustrating by way of example communications and operations related to the method shown in FIG. 2. In communication 302, a request from account holder 110 is received by organization 120, the request being a request to link a payment account to organization 120. In an example implementation, the communication between account holder 110 and organization 120 is web-based. In certain examples, account holder 110 interacts with web browser in communication with a web server managed by organization 120 or account holder 110 interacts with a mobile app or other local application that interacts with a server having a REST or other type of API exposed. In either case, account holder 110 interacts with a user interface provided by organization 120 to initiate communication 302.

In response to receiving communication 302, organization 120 transmits a request for transaction details in communication 304. In a web environment, this request may be in the form of a web form to be filled by account holder 110. In a local application, a form may be displayed in response to receiving communication 302 that instructs mobile application to obtain the transaction details.

In certain examples where business logic defined by organization 120 resides within a local application running on the account holder's device, communications 302 and 304 are not needed. In this case, the user interacts with the local application to request a particular payment account to be linked and the local application displays a form that asks for the required information.

In one example implementation, the account holder is asked to select any transaction that meets certain criteria to enhance the strength of the authentication. In one example, the criteria includes that the selected transaction be more than a certain number of days old (e.g., 30, 60, or 90 days old). In another example, the criteria includes that the selected transaction be one in which a physical payment card was presented to a merchant. In yet another example, the criteria includes that the selected transaction exceeds a particular currency amount, e.g., greater than $500. Any one or more of these criteria may be included and, in example implementations, the criteria varies depending on authentication requirements determined by payment network 130.

Communication 306 comprises requested details of the selected account and is transmitted by account holder 110 to organization 120. In response to receiving communication 306, organization 120 transmits communication 308 comprising a request for authentication to payment network 130. Communication 308, in various example implementations, comprise a GET request via a webserver or REST API or other remote procedure call (RPC) mechanism including WebSockets, gRPC, a custom protocol, etc.

Upon receipt of communication 308, payment network 130 performs a validation process 310 to validate the details of the selected transaction by comparing them with details of the same transaction as maintained in transaction database 134 (FIG. 1) by payment network 130. If the transaction details in authentication request of communication 308 match the transaction details in transaction database 134, then the authentication request is validated.

Optionally, an assessment 312 may be performed by payment network 130. The assessment is a determination of risk that the person purporting to be account holder 110 is not actually the true account holder, or that the organization is not in a relationship with the account holder 110. The assessment is based on an analysis of the transaction data for risk factors. In one example, if a risk factor is present, then the authentication request is flagged as being suspicious and additional authentication requirements may be imposed before the authentication request is approved. In this example, payment network 130 generates an assessment risk score and then determines, based on the risk score, whether additional authentication data is needed.

In another example, the presence of one or more risk factors are combined heuristically into a risk score, with increased authentication requirements being imposed with increased risk scores. Example risk factors include (1) an identification that there were no transactions over a previous number of months prior to a recent transaction request being received; (2) a change in a frequency of transaction requests; (3) a change in a user's device details; (4) a change in a time zone or geographical location; (5) a failure to present a payment card over a specified period of time; (6) a failure to complete a multi-factor authentication demand; (7) whether any known data breaches involving the payment account have occurred; and the like. In certain example implementations, increased risk scores result in a demand to satisfy a stronger authentication requirement. Examples of stronger authentication requirements include providing details of an additional number of past transactions that are spread across multiple merchants and/or multiple months; a requirement to create or select a transaction with a vendor involving the presenting of a payment card tied to the payment account; a requirement to create or select a transaction involving a multi-factor authentication demand, e.g., where the transaction amount is over a specified threshold currency amount, e.g., $500.

In yet another example implementation, assessment 312 may involve a machine learning (ML) model trained using transaction history of known uncompromised and known compromised accounts. In certain examples, before performing the training, the training data is normalized and/or one-hot or label-encoded. Domain-specific features such as transaction amounts, time of transaction, frequency of transaction, location (geographic or other) information, device characteristics, etc., is extracted and new features may be derived such as an average number of transactions in a given period. Suitable supervised learning model types include logistic regression, decision tree, random forests, gradient boosting machines, support vector machines, and neural networks, including deep neural networks. Once the model is trained, assessment process 312 includes performing the same normalizing and encoding process on the transaction history of the payment account and then inputting it into the ML model to obtain a confidence score indicating that the payment account has been compromised in some way or not. This confidence score is therefore a risk score as described above such that when it is above a threshold, additional authentication measures would be undertaken to mitigate the risk.

Once validation 310 and assessment 312 are complete, an authentication response 314 is communicated to organization 120. Authentication response 314 is an “authentication approved” message, an “authentication denied” message, or a message indicating that additional authentication steps are required.

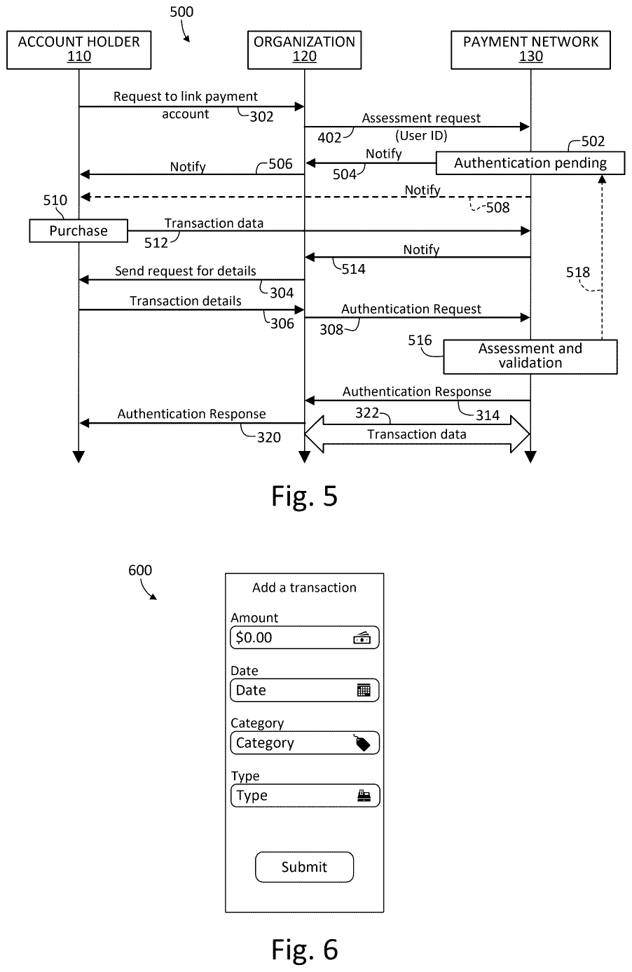

In operation 316, organization 120 receives authentication response 314 and proceeds accordingly. If the authentication response includes an approval or a denial of the request, then that response is passed to account holder 110. If additional authentication steps are required then the process loops back as indicated by dashed arrow 318 and a new communication 304 is generated requesting the additional details for additional transactions from account holder 110. In one example, the additional details include details for one or more additional past transactions. In another option, the process proceeds with additional requirements including a new strongly authenticated transaction as further described below with reference to FIG. 5. If authentication is approved, then approval is indicated in authentication response 320 and organization 120 is permitted access to transaction data from payment network 130 as indicated by transaction data arrow 322.

As described above, payment network 130 serves as the authenticator. However, alternative implementations are contemplated in which a separate entity serves as the authenticator and performs the operations attributed to the payment network in the above description. In this case, details of the past transaction provided by account holder 110 are compared against details of the same transaction fetched from transaction database 134 managed by payment network 130 via an API made accessible to the authenticator.

FIG. 4 shows a time-space diagram 400 illustrating by way of example an alternate approach for communications and operations related to the method shown in FIG. 2. In this figure, features similar to those previously described in FIG. 3 are given the same reference number. Conceptually, this implementation example involves a separation of the assessment and validation processes into separate transactions with organization 120.

As discussed above, communication 302 includes a request by account holder 110 to link a payment account with his account in organization 120. In response, organization 120 transmits communication 402 comprising an assessment request to payment network 130. The assessment request is essentially a request for instructions on what information is needed from account holder 110 based on a risk assessment. The assessment request will include user identification sufficient to enable payment network 130 to locate the account holder's account information, and may include, e.g., the last four digits of the account holder's account number, which could have been previously obtained by organization 120 or provided to organization 120 within or concomitantly with communication 302.

Upon receipt of communication 402, payment network 130 accesses the transaction history information associated with the payment account of account holder 110 and performs assessment 312 as previously described. Responsive to completion of assessment 312, communication 404 is generated that includes an authentication data requirement, which provides instructions to organization 120 to gather information from account holder 110 that is necessary to perform authentication. The type and/or amount of information required as defined in the authentication data requirement depends on the result of the assessment. For example, for an account deemed risky, authentication data requirement may require details of two or three historical transactions each having occurred in different months and more than 90 days ago, whereas a less risky account may only require details of a single historical transaction that occurred at least 30 days ago. It should be understood that the terms “risky account” or “less risky account” refers to payment accounts that are more or less likely to have been compromised in some way. Upon receipt of communication 404 by organization 120, at least some of the communications and operations 304-322 occur as previously described above.

As described above, payment network 130 serves as the authenticator. However, alternative implementations are contemplated in which a separate entity serves as the authenticator and performs the operations attributed to the payment network in the above description. In this case, details of the past transaction provided by account holder 110 are compared against details of the same transaction fetched from transaction database 134 managed by payment network 130 via an API made accessible to the authenticator.

FIG. 5 shows another time-space diagram 500 illustrating by way of example a communication pattern suitable for authenticating an account holder 110 when the payment account is too new or otherwise lacks a transaction history for authenticating using previously described approaches. In this figure, features similar to those previously described in FIGS. 3 and 4 are given the same reference number. An initial communication 302 for requesting organization 120 to link a payment account is transmitted from account holder 110 to organization 120 as previously described. This triggers communication 402 comprising an assessment request as previously described. In this instance, the assessment determines that the transaction history for the payment account is non-existent or too recent to rely on knowledge of details of past transactions to be sufficient for authentication. Accordingly, payment network 130 places the authentication into a “pending” status as indicated in authentication pending block 502 and transmits communication 504 to organization 120 to notify organization 120 of the pending status and provide instructions as to what needs to happen next for account holder 110 to be authenticated. Organization 120 passes this (or similar) notification to account holder 110 via communication 506. Alternatively, or in addition to communication 504, payment network 130 transmits a communication 508 notifying account holder 110 directly.

Communications 504, 506, and 508 relate to instructions to account holder 110 to inform account holder 110 what actions account holder 110 needs to complete in order to be authenticated. If account holder 110 is communicating to organization 120 via a web interface, then organization 120 may transmit communication 506 in the form of a web page providing appropriate instructions to account holder 110. If account holder 110 is accessing services from organization 120 via a local application (e.g., a mobile app) then in an example implementation, communication 506 is in the form of a simple instruction to the local application to display the appropriate authentication instructions to account holder 110.

In some cases, the instructions direct the account holder to participate in certain types of transactions before authentication can be approved. The number of transactions and transaction types will vary depending on requirements of payment network 130, and in example implementations, vary based on assessed risk score and/or account characteristics such as home country of account holder 110 or if any known data breaches involving the payment account have occurred.

Exemplary types of transactions that account holder 110 may be instructed to engage in include (1) a transaction in which account holder 110 presents a physical payment card as part of the transaction or (2) a transaction over a specified currency amount to trigger a multi-factor authentication that must be successfully satisfied before the transaction is completed. In some cases, multiple transactions of these types could be required or one of each of these types of transactions may be required. It also may be a requirement that such transactions occur within a limited time period, such as 7 days from the receipt of communication 506 or 508.

At some point, account holder 110 engages in a transaction of the designated type as indicated by purchase 510. As a normal part of the transaction processing, transaction data 512 related to the transaction is communicated to payment network 130. It should be noted that this communication may not be direct and generally will involve an intermediate acquirer bank (not shown) as previously described.

Upon receipt of transaction data 512 corresponding to purchase 510, payment network 130 transmits communication 514 to notify organization 120 that an authenticating transaction may have occurred to obtain details of the transaction from account holder 110. Communications 304, 306, and 308 then proceed as previously described. At operation 516, upon receipt of communication 308 comprising an authentication request, assessment and validation is performed by payment network 130 on transaction information obtained from account holder 110. Validation proceeds as previously described by comparing details of the transaction included in authentication request of communication 308 with details of the same transaction stored in transaction database 134. If the details match then the transaction details are validated. In addition, an assessment is performed to determine if the provided details sufficiently mitigate risk associated with the payment account, or if all the initial authentication requirements communicated in communications 504 or 506 are satisfied. If additional information is needed, then the procedure returns to authentication pending block 502 as indicated by dashed arrow 518, and additional details are demanded as previously described above. Similarly, if the assessment indicates that details of the transactions should satisfy the authentication requirements then at least some of the communications 314-322 proceed as previously described.

As described above, payment network 130 serves as the authenticator. However, alternative implementations are contemplated in which a separate entity serves as the authenticator and performs the operations attributed to the payment network in the above description. In this case, details of the past transaction provided by account holder 110 are validated using details of the same transaction fetched from transaction database 134 managed by payment network 130 via an API made accessible to the authenticator.

FIG. 6 illustrates by way of example a user interface 600 suitable for obtaining details of a transaction. User interface 600 includes a set of fields for obtaining different attributes of the transaction, including an “amount” field for the currency amount of the transaction, a “date” field for the date of the transaction, a “category” field for the category of goods or services corresponding to the transaction, and a “type” field for the type of transaction. In the amount field, account holder 110 enters a dollar amount (or, e.g. if the transaction is in euros, the euro amount, etc.) of the transaction. Likewise, account holder 110 will enter the date of the transaction in the date field. If the authentication requirement is that the transaction be at least a certain number of days in the past, then a validation check will ensure that the user selects a sufficiently old transaction to satisfy the authentication requirement. The validation check is performed within the user interface 600 and entry of values that do not satisfy the authentication requirements are not allowed. The category field may be a drop-down field that includes options selectable by account holder 110 including such things as travel, dining, restaurant, grocery, gasoline station/convenience, fast food, or other. Likewise, the type field may be a drop-down set of options for selecting including “online sale,” “physical card presented,” “mobile payment” (e.g., Google Pay, Apple Pay, etc.) “multi-factor authenticated,” etc.

Finally, once account holder 110 entered this information they may press the submit button to cause a transmission of the data to organization 120 as previously described.

### Additional Examples

An example system comprises: a method of authenticating an account holder, the account holder being an authorized user of a payment account, the payment account being one of a credit account or a debit account. The method comprises receiving, from an organization, an authentication request, the authentication request being a request to authenticate the account holder, the authentication request including details of a past transaction provided to the organization by the account holder; and communicating a response to the authentication request, the response being communicated to the organization, the response including a message indicating approval or denial of the authentication request based on whether the details of the past transaction match information stored in a transaction database managed by the payment network.

In certain examples, the method further comprises:
receiving a request from the organization for transaction data associated with the account holder; and responsive to the request for transaction data, determining that the authentication request is approved; and responsive to determining that the authentication request is approved, providing the transaction data to the organization.
wherein the details of the past transaction comprises one or more of: a transaction currency amount, a transaction date, a transaction category, and a transaction type, wherein the transaction category identifies a category of goods or services purchased and the transaction type identifies a manner of engaging in the transaction.
prior to the communicating of the response, generating an initial response to the authentication request, the initial response indicating that, based on an assessment of risk that the payment account has been compromised, additional authentication data is needed, the assessment of risk being based on an analysis of transaction data associated with the payment account; and receiving from the organization an additional authentication request, the additional authentication request including additional details of one or more additional past transactions provided to the organization by the account holder; wherein the message included in the response to the authentication request indicates approval or denial of the authentication request based on whether the details of the past transaction and the additional details of the one or more additional past transactions match information stored in the transaction database.
prior to receiving the authentication request, receiving an assessment request from the organization for the payment account; in response to the receiving of the assessment request, performing an assessment of risk that the payment account has been compromised, the assessment of risk comprising an analysis of transaction data associated with the payment account; determining an authentication data requirement based on a result of the assessment of risk; and transmitting a communication comprising the authentication data requirement to the organization. The message indicates approval or denial of the authentication request based on whether the authentication data requirement is met by information provided in the authentication request.
the authentication data requirement includes a requirement that the information provided by authentication request comprises details of at least a specified number of past transactions wherein specified number is two or more; and the message indicates approval or denial of the authentication request based on whether details of the specified number of past transactions match information stored in the transaction database.
the authentication data requirement includes a requirement that the past transaction that occurred at least a particular number of days prior to a date of the authentication request.
the authentication data requirement includes one of a requirement that the past transaction is one that was strongly authenticated using a multi-factor authentication scheme or a requirement that the past transaction is one in which the account holder presented a physical payment card as part of the transaction.
the past transaction is selected by the account holder.
prior to receiving the authentication request, receiving an assessment request from the organization for the payment account; determining that the payment account lacks sufficient transaction history for assessment and/or authentication; in response to the determining that the payment account lacks sufficient transaction history, placing the account holder on a pending status; communicating a pending status notification to one of the organization and the account holder, the pending status notification indicating that the authentication is pending receipt of additional transaction data. Subsequent to the notifying, receiving a transaction request associated with a purchase using the payment account, the transaction request comprising additional transaction data and communicating a transaction received notification to one of the organization and the account holder, wherein the authentication request is received in response to the transaction received notification.
wherein the pending status notification includes an indication of an authentication data requirement. In addition, an assessment is to determine whether the details of the past transaction meet the authentication data requirement and based on the assessment, determining whether additional transaction data is needed, and based determining that additional transaction data is needed, sending an additional pending status notification and waiting for a receipt of an additional transaction request.

In another example, a system is provided for authenticating an account holder, the account holder being an authorized user of a payment account, the payment account being one of a credit account or a debit account. The system comprises one or more computer processors capable of executing instructions, a memory storage system, the memory storage system being capable of non-transitory storage of the instructions, and instructions stored in the memory storage system, the instruction causing the one or more processors to, upon execution, perform a method, the method comprising receiving, from an organization, an authentication request, the authentication request being a request to authenticate the account holder, the authentication request including details of a past transaction provided to the organization by the account holder and communicating a response to the authentication request, the response being communicated to the organization, the response including a message indicating approval or denial of the authentication request based on whether the details of the past transaction match information stored in a transaction database managed by the payment network.

In certain examples, the system further includes:
wherein the method further comprises receiving a request from the organization for transaction data associated with the account holder; responsive to the request for transaction data, determining that the authentication request is approved; and responsive to determining that the authentication request is approved, providing the transaction data to the organization.
wherein the method further comprises prior to the communicating of the response generating an initial response to the authentication request, the initial response indicating that, based on an assessment of risk that the payment account has been compromised, additional authentication data is needed, the assessment of risk being based on an analysis of transaction data associated with the payment account; and receiving from the organization an additional authentication request, the additional authentication request including additional details of one or more additional past transactions provided to the organization by the account holder. The message included in the response to the authentication request indicates approval or denial of the authentication request based on whether the details of the past transaction and the additional details of the one or more additional past transactions match information stored in the transaction database.
wherein the method further comprises, prior to receiving the authentication request, receiving an assessment request from the organization for the payment account; in response to the receiving of the assessment request, performing an assessment of risk that the payment account has been compromised, the assessment of risk comprising an analysis of transaction data associated with the payment account; determining an authentication data requirement based on a result of the assessment of risk; and transmitting a communication comprising the authentication data requirement to the organization. The message indicates approval or denial of the authentication request based on whether the authentication data requirement is met by information provided in the authentication request.
wherein the authentication data requirement includes a requirement that the information provided by authentication request comprises details of at least a specified number of past transactions wherein specified number is two or more; and the message indicates approval or denial of the authentication request based on whether details of the specified number of past transactions match information stored in the transaction database.
wherein the authentication data requirement includes a requirement that the past transaction that occurred at least a particular number of days prior to a date of the authentication request.
wherein the authentication data requirement includes one of a requirement that the past transaction is one that was strongly authenticated using a multi-factor authentication scheme or a requirement that the past transaction is one in which the account holder presented a physical payment card as part of the transaction.
wherein the method further comprise, prior to receiving the authentication request, receiving an assessment request from the organization for the payment account; determining that the payment account lacks sufficient transaction history for assessment and/or authentication; in response to the determining that the payment account lacks sufficient transaction history, placing the account holder on a pending status; communicating a pending status notification to one of the organization and the account holder, the pending status notification indicating that the authentication is pending receipt of additional transaction data. Subsequent to the notifying, receiving a transaction request associated with a purchase using the payment account, the transaction request comprising additional transaction data; and communicating a transaction received notification to one of the organization and the account holder, wherein the authentication request is received in response to the transaction received notification.
wherein the pending status notification includes an indication of an authentication data requirement and the method further comprises performing an assessment to determine whether the details of the past transaction meet the authentication data requirement; based on the assessment, determining whether additional transaction data is needed, and based determining that additional transaction data is needed, sending an additional pending status notification and waiting for a receipt of an additional transaction request.

### Exemplary Operating Environment

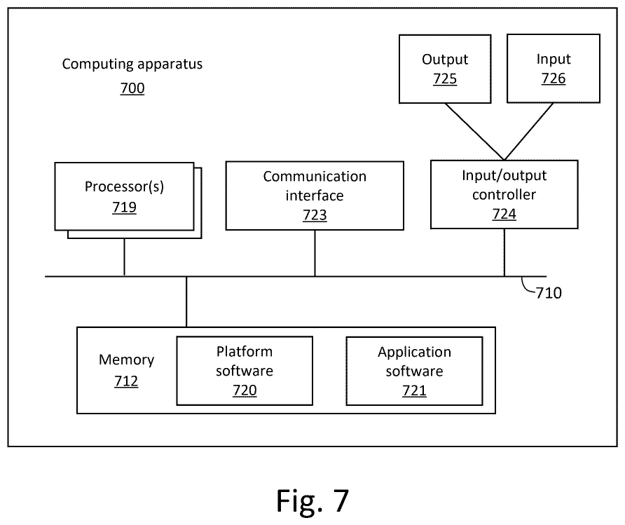

The present disclosure is operable with a computing apparatus according to an embodiment as a functional block diagram of a computing apparatus 700 in FIG. 7. In an embodiment, components of a computing apparatus 700 may be implemented as a part of an electronic device according to one or more embodiments described in this specification. The computing apparatus 700 is a computing device, such as, but not limited to, the computing devices associated with or managed by each entities 110, 120, and 130 illustrated in FIGS. 1 and 3-5. In some examples, one or more computing apparatuses 700 are provided for an on-premises computing solution. In some examples, one or more computing apparatuses 700 are provided as a cloud computing solution. In some examples, a combination of on-premises and cloud computing solutions are used. Computing apparatus 700 is but one example of a suitable computing environment and is not intended to suggest any limitation as to the scope of use or functionality of the examples disclosed herein, whether used singly or as part of a larger set.

The computing apparatus 700 comprises data bus 710 placing processors 719, communication interface 723, input/output controller 724, and memory 712 in communication with one another. One or more processors 719 may be microprocessors, controllers, or any other suitable type of processors for processing computer executable instructions to control the operation of the electronic device. Alternatively, or in addition, the processor 719 is any technology capable of executing logic or instructions, such as a hardcoded machine.

Platform software 720 comprising an operating system and/or any other suitable platform software may be provided on the apparatus 700 to enable application software 721 to be executed on the device. Platform software, in certain implementations, include infrastructure and orchestration software such as virtualization software including a hypervisor or containerization software.

Computer executable instructions may be provided using any computer-readable media accessible by the computing apparatus 700. Computer-readable media may include, for example, computer storage media such as a memory 712 and communications media.

Computer storage media, such as a memory 712, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology including optical storage, magnetic storage, or any other non-transmission medium usable to store information for access by a computing apparatus.

In contrast, communication media may encode computer readable instructions, data structures, program modules, or the like in a modulated data signal, such as a carrier wave, or other transport mechanism. As defined herein, computer storage media do not include communication media. Therefore, a computer storage medium is not a propagating signal. Although the computer storage medium (the memory 712) is shown within the computing apparatus 700, it should be appreciated that the storage may be distributed or located remotely and accessed via a network or other communication link (e.g., using a communication interface 723).

The computing apparatus 700 may comprise an input/output controller 724 configured to output information to one or more output devices 725, for example a display or a speaker, which may be separate from or integral to the computing apparatus. The input/output controller 724 may also be configured to receive and process an input from one or more input devices 726, for example, a keyboard, mouse, or a touchpad. In one embodiment, the output device 725 may also act as the input device. An example of such a device may be a touch sensitive display. The input/output controller 724 may also output data to devices other than the output device, e.g., a locally connected printing device, data interfaces, etc. In some embodiments, a user may provide input to the input device(s) 726 and/or receive output from the output device(s) 725.

The functionality described herein is able to be performed, at least in part, by one or more hardware logic components. According to an embodiment, the computing apparatus 700 is configured by the program code when executed by the processor 719 to execute the embodiments of the operations and functionality described. Alternatively, or in addition, the functionality described herein is able to be performed, at least in part, by one or more hardware logic components. For example, and without limitation, illustrative types of hardware logic components include Field-programmable Gate Arrays (FPGAs), Application-specific Integrated Circuits (ASICs), Program-Specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it is able to execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A computerized method of authenticating an account holder, the account holder being an authorized user of a payment account, the payment account being one of a credit account or a debit account, the method comprising:
receiving, by an authenticator, from an organization, an authentication request, the authentication request being a request to authenticate the account holder, the authentication request including details of a past transaction provided to the organization by the account holder, the past transaction being a payment transaction related to a purchase made by the account holder; and
communicating a response to the authentication request, the response being communicated to the organization, the response including a message indicating approval or denial of the authentication request based on whether the details of the past transaction match information stored in a transaction database managed by a payment network that processes transactions for the payment account.

2. The method of claim 1, wherein the method further comprises:
receiving a request from the organization for transaction data associated with the account holder; and
responsive to the request for transaction data, determining that the authentication request is approved; and
responsive to determining that the authentication request is approved, providing the transaction data to the organization.

3. The method of claim 1, wherein the details of the past transaction comprises one or more of: a transaction currency amount, a transaction date, a transaction category, and a transaction type, wherein the transaction category identifies a category of goods or services purchased and the transaction type identifies a manner of engaging in the transaction.

4. The method of claim 1, further comprising:
prior to the communicating the response:
generating an initial response to the authentication request, the initial response indicating that, based on an assessment of risk that the payment account has been compromised, additional authentication data is needed, the assessment of risk being based on an analysis of transaction data associated with the payment account; and
receiving from the organization an additional authentication request, the additional authentication request including additional details of one or more additional past transactions provided to the organization by the account holder,
wherein the message included in the response to the authentication request indicates approval or denial of the authentication request based on whether the details of the past transaction and the additional details of the one or more additional past transactions match information stored in the transaction database.

5. The method of claim 1, further comprising:
prior to receiving the authentication request:
receiving an assessment request from the organization for the payment account;
in response to the receiving of the assessment request, performing an assessment of risk that the payment account has been compromised, the assessment of risk comprising an analysis of transaction data associated with the payment account;
determining an authentication data requirement based on a result of the assessment of risk; and
transmitting a communication comprising the authentication data requirement to the organization,
wherein the message indicates approval or denial of the authentication request based on whether the authentication data requirement is met by information provided in the authentication request.

6. The method of claim 5, wherein:
the authentication data requirement includes a requirement that the information provided in the authentication request comprises details of at least a specified number of past transactions, wherein the specified number is two or more; and
the message indicates approval or denial of the authentication request based on whether details of the specified number of past transactions match information stored in the transaction database.

7. The method of claim 5, wherein the authentication data requirement includes a requirement that the past transaction occurred at least a particular number of days prior to a date of the authentication request.

8. The method of claim 5, wherein the authentication data requirement includes one of:
a requirement that the past transaction is one that was strongly authenticated using a multi-factor authentication scheme; or
a requirement that the past transaction is one in which the account holder presented a physical payment card as part of the past transaction.

9. The method of claim 1, wherein the past transaction was selected by the account holder.

10. The method of claim 1, further comprising:
prior to receiving the authentication request:
receiving an assessment request from the organization for the payment account;
determining that the payment account lacks sufficient transaction history for assessment and/or authentication;
in response to the determining that the payment account lacks sufficient transaction history, placing the payment account on an authentication-pending status;
communicating a pending status notification to one of the organization and the account holder, the pending status notification indicating that authentication is pending receipt of additional transaction data;
subsequent to the communication of the pending status notification, receiving a transaction request associated with a purchase using the payment account, the transaction request comprising additional transaction data; and
communicating a transaction received notification to one of the organization and the account holder, wherein the authentication request is received in response to the transaction received notification.

11. The method of claim 10, wherein the pending status notification includes an indication of an authentication data requirement, the method further comprising:
performing an assessment to determine whether the details of the past transaction meet the authentication data requirement;
based on the assessment, determining that additional transaction data is needed; and
based on the determining that the additional transaction data is needed, sending an additional pending status notification and waiting for a receipt of an additional transaction request.

12. A system for authenticating an account holder, the account holder being an authorized user of a payment account, the payment account being one of a credit account or a debit account, the system comprising:
one or more computer processors capable of executing instructions;
a memory storage system, the memory storage system being capable of non-transitory storage of the instructions; and
instructions stored in the memory storage system, the instruction causing the one or more computer processors to, upon execution, perform a method, the method comprising:
receiving, by an authenticator, from an organization, an authentication request, the authentication request being a request to authenticate the account holder, the authentication request including details of a past transaction provided to the organization by the account holder, the past transaction being a payment transaction related to a purchase made by the account holder; and
communicating a response to the authentication request, the response being communicated to the organization, the response including a message indicating approval or denial of the authentication request based on whether the details of the past transaction match information stored in a transaction database managed by a payment network that processes transactions for the payment account.

13. The system of claim 12, wherein the method further comprises:
receiving a request from the organization for transaction data associated with the account holder; and
responsive to the request for transaction data, determining that the authentication request is approved; and
responsive to determining that the authentication request is approved, providing the transaction data to the organization.

14. The system of claim 12, wherein the method further comprises:
prior to the communicating the response:
generating an initial response to the authentication request, the initial response indicating that, based on an assessment of risk that the payment account has been compromised, additional authentication data is needed, the assessment of risk being based on an analysis of transaction data associated with the payment account; and
receiving from the organization an additional authentication request, the additional authentication request including additional details of one or more additional past transactions provided to the organization by the account holder,
wherein the message included in the response to the authentication request indicates approval or denial of the authentication request based on whether the details of the past transaction and the additional details of the one or more additional past transactions match information stored in the transaction database.

15. The system of claim 12, wherein the method further comprises:
prior to receiving the authentication request:
receiving an assessment request from the organization for the payment account;
in response to the receiving of the assessment request, performing an assessment of risk that the payment account has been compromised, the assessment of risk comprising an analysis of transaction data associated with the payment account;
determining an authentication data requirement based on a result of the assessment of risk; and
transmitting a communication comprising the authentication data requirement to the organization,
wherein the message indicates approval or denial of the authentication request based on whether the authentication data requirement is met by information provided in the authentication request.

16. The system of claim 15, wherein:
the authentication data requirement includes a requirement that the information provided in the authentication request comprises details of at least a specified number of past transactions wherein the specified number is two or more; and
the message indicates approval or denial of the authentication request based on whether details of the specified number of past transactions match information stored in the transaction database.

17. The system of claim 15, wherein the authentication data requirement includes a requirement that the past transaction occurred at least a particular number of days prior to a date of the authentication request.

18. The system of claim 15, wherein the authentication data requirement includes one of:
a requirement that the past transaction is one that was strongly authenticated using a multi-factor authentication scheme; or
a requirement that the past transaction is one in which the account holder presented a physical payment card as part of the past transaction.

19. The system of claim 12, wherein the method further comprises:
prior to receiving the authentication request:
receiving an assessment request from the organization for the payment account;
determining that the payment account lacks sufficient transaction history for assessment and/or authentication;
in response to the determining that the payment account lacks sufficient transaction history, placing the payment account on an authentication-pending status;
communicating a pending status notification to one of the organization and the account holder, the pending status notification indicating that authentication is pending receipt of additional transaction data;
subsequent to the communicating of the pending status notification, receiving a transaction request associated with a purchase using the payment account, the transaction request comprising additional transaction data; and
communicating a transaction received notification to one of the organization and the account holder, wherein the authentication request is received in response to the transaction received notification.

20. The system of claim 19, wherein the pending status notification includes an indication of an authentication data requirement and the method further comprises:
performing an assessment to determine whether the details of the past transaction meet the authentication data requirement;
based on the assessment, determining that additional transaction data is needed; and
based on the determining that additional transaction data is needed, sending an additional pending status notification and waiting for a receipt of an additional transaction request.
